(19) United States
(12) Patent Application Publication
(10) Pub. No.: US 2025/0248884 A1
(43) Pub. Date: Aug. 7, 2025

(54) PROSTATE MASSAGE DEVICE

(71) Applicant: Jun Hyeong YUN, Gumi-si, Gyeongsangbuk-do (KR)

(72) Inventor: Jun Hyeong YUN, Gumi-si, Gyeongsangbuk-do (KR)

(21) Appl. No.: 18/856,890

(22) PCT Filed: Apr. 13, 2023
(86) PCT No.: PCT/KR2023/005016

§ 371 Date: Oct. 15, 2024

(30) Foreign Application Priority Data
Apr. 19, 2022 (KR) 10-2022-0048342

(51) Int. Cl. A61H 19/00; A61H 15/00

(52) U.S. Cl. CPC A61H 19/00; A61H 15/0078; A61H 2015/0014; A61H 2201/0192; A61H 2201/1207; A61H 2201/1418; A61H 2201/1669; A61H 2205/087

(57) ABSTRACT

A prostate massage device (200) includes: a base body (210); a support (220) installed standing in the center of the base body; a long hole (221) formed at the upper end of the support; a cylindrical guide member (230) of which one end is fixed through a fixing pin (222); a massage roller moving rod (240) that is inserted into the cylindrical guide member; a massage roller (250) fixed to one end of the massage roller moving rod; a drive motor (247) installed in the base body; a disc-shaped gear (246) that rotates by engaging with the drive motor; a drive arm (245) of which one side is linked to the other end of the massage roller moving rod (240); a height adjustment member (260) that supports the other end of the cylindrical guide member; and a top plate cover (270) in which a straight line groove (271) is formed.

### TECHNICAL FIELD

The present invention relates to a prostate massage device, and more specifically, to a massage device capable of increasing massage efficiency to allow blood to flow smoothly between an anus and a genital organ of a human body, thereby preventing prostate disease in men and urinary incontinence disease in women.

### BACKGROUND ART

The prostate and urinary tract of the human body are located in the perineum, which is located in the middle between the anus and genitals, and it is known that when the perineum is massaged by applying appropriate vibrations or pressure thereto, the dysfunction or occurrence of diseases in the prostate and urinary tract can be prevented.

An example of a general prostate massager is disclosed in Korean Patent Registration No. 10-1525585.

As shown in FIGS. 1 and 2, a conventional prostate massage device 100 includes a bottom frame 50 and middle frames 60 that are formed at both sides thereof to be supported on a floor surface of an indoors and formed integrally by being connected to an upper handle rod 70 using vertical shafts 40 and 41.

Between the middle frames 60, a portion of a circular wheel 12 of a rotating body 10 with a diameter of 20 to 30 cm protrudes outward from a horizontal surface of a chair board 30 and the protruding wheel portion is formed in a structure that may be rotated by its weight.

In addition, upper end portions of the middle frames 60 at both sides are provided with a rail 61, and the chair board 30 installed horizontally between the middle frame 60 and the upper handle rod 70 has a hole 31 in the form of a long axis hole of 15 to 30 cm formed in a central portion thereof. In the hole 31, a wheel protrusion of the rotating body 10 supported by the middle frame 60 is made in the form of protruding 1 to 3 cm upward from the horizontal surface of the chair board 30. Rail holders 32 are fixed to lower portions of both sides of the chair board 30, and the rail holders 32 at both sides are formed in a structure that surrounds the rail 61 formed on an upper end of the middle frame 60.

The above structure is operated so that the wheel protrusion of the rotating body 10 presses and massages the perineum between the anus and genitals of the human body as a user sits on the chair board 30, holds the upper handle rod 70, and moves the chair board 30 forward and backward.

In addition, the middle frame 60 is formed so that the rail 61 is installed on the upper central portion thereof and the rail holder 32 of the chair board 30 surrounds the rail 61 so as not to escape from the rail. At both sides of a bottom surface of the chair board 30, a concave groove-shaped screw coupling hole 33 is formed to fix the rail holder 32 of the lower portion to the chair board 30.

Meanwhile, the rotating body 10 is connected to a fixed shaft 22 connected to a floor surface fixed plate 23 and a U-shaped support member 21 formed with an accommodation groove 21a that accommodates the fixed shaft 22 to form a shock absorber. An elastic spring 24 is embedded in the fixed shaft 22 connected to the floor surface fixed plate 23 to form a structure that is pressed by a lower end portion of the U-shaped support member 21, and an upper end portion 22a of the fixed shaft is positioned in a cylindrical shape inside the accommodation groove 21a formed in the central portion of the U-shaped support member 21 to operate a structure in which, when the user sits on the chair board 30 and moves forward and backward while pressing the protrusion of the rotating body 10, the rotating body 10 is pushed about 2 to 10 mm downward and then returns to its original position by elasticity.

The rotating body 10 may include the circular wheel 12 made of a metallic material, such as copper, with high thermal conductivity, and a hot water inlet 14 and a rubber cap 15 may be formed at one side of the circular wheel 12.

The conventional prostate massage device 100 formed as described above has a disadvantage that it is inconvenient to use because the user needs to sit on the chair board 30 and move the chair board 30 forward and backward along the rail. In addition, since an elastic load of the rotating body 10 that performs massage is applied by only the operation of the elastic spring 24, there is a structural problem that the massage pressing strength is constant regardless of the position of the chair board 30, thereby lowering the touch sense and efficiency of the massage.

### DETAILED DESCRIPTION OF INVENTION

### Technical Problem

The present invention is intended to solve the above problems and is directed to providing a prostate massage device capable of performing massage while varying pressing strength with a simple structure.

The present invention is also directed to providing a prostate massage device with improved touch quality of a massage roller contact portion.

### Technical Solution

To achieve the above objects, a prostate massage device according to the present invention includes a base body, a support installed at a center of the base body, a long hole formed in an upper end portion of the support in a longitudinal direction of the support, a cylindrical guide member of which one end is fixed in the long hole with a fixing pin, which is coupled to the long hole, interposed therebetween, a massage roller moving rod fitted into the cylindrical guide member to reciprocate, a massage roller fixed to one end of the massage roller moving rod,
a drive motor installed on the base body, a disc-shaped gear engaged with the drive motor to rotate, a drive arm of which one side is linked to the other end of the massage roller moving rod and the other side is eccentrically linked to the disc-shaped gear,
a height adjustment member supporting the other end of the cylindrical guide member to adjust a height of the cylindrical guide member, and a top plate cover provided with a straight line groove so that a portion of the massage roller is exposed.

In addition, the cylindrical guide member may be movable along the long hole, and the height adjustment member may be in contact with the cylindrical guide member with an elastic member interposed therebetween.

### Advantageous Effects

A prostate massage device according to the present invention can perform a massage while pressing strength varies depending on a position of a massage roller.

In particular, when a massage roller moving rod is fitted into a cylindrical guide member and reciprocates, the cylindrical guide member slightly moves upward and downward along a long hole with respect to a fixing pin so that the massage roller moves in a streamlined way rather than in a straight line, and thereby the pressing strength of the massage roller with respect to the human body changes depending on positions.

### DESCRIPTION OF DRAWINGS

FIG. 1 is a three-dimensional view of the conventional prostate message device.

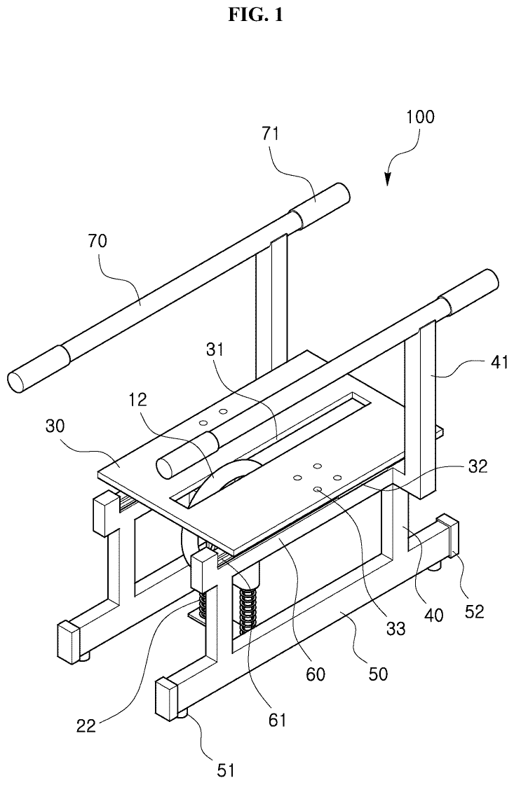

FIG. 2 is a cross-sectional view of a rotating body of the conventional prostate massage device.

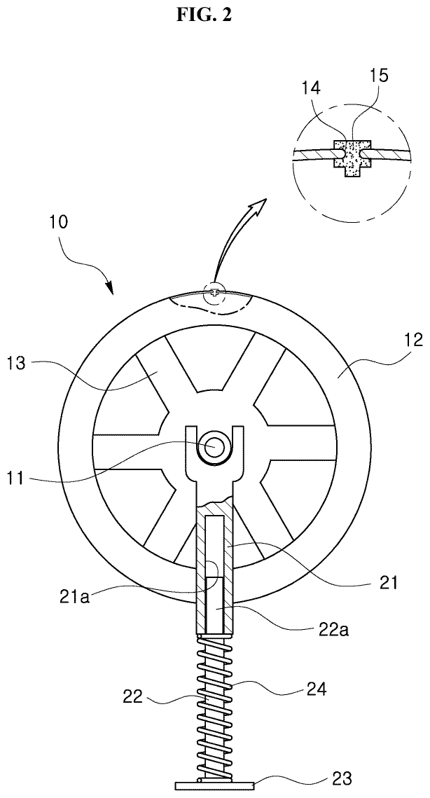

FIG. 3 is a three-dimensional view of main parts of a prostate massage device according to the present invention.

FIG. 4 is a plan view of the prostate massage device according to the present invention.

FIG. 5 is a side view of the prostate massage device according to the present invention.

FIG. 6 is a side view showing a state in which a massage roller of the prostate massage device according to the present invention is moved inward.

FIG. 7 is an exemplary view showing a height adjustment member of the prostate massage device according to the present invention.

### DESCRIPTION OF DRAWING SYMBOLS

200—prostate massage device, 210—base body, 220—support
221—long hole, 222—fixing pin, 230—cylindrical guide member
240—massage roller moving rod, 245—drive arm
246—disk-shaped gear, 247—drive motor, 250—massage roller
260—height adjustment member, 261—eccentric cam, 262—operation pin
263—spring, 270—top plate cover, 271—straight line groove

### Best Mode of the Invention

A prostate massage device 200 according to the present invention includes a base body 210, a support 220 installed at a center of the base body, a long hole 221 formed in an upper end portion of the support in a longitudinal direction of the support, a cylindrical guide member 230 of which one end is fixed in the long hole with a fixing pin 222, which is coupled to the long hole, interposed therebetween, a massage roller moving rod 240 fitted into the cylindrical guide member to reciprocate, a massage roller 250 fixed to one end of the massage roller moving rod, a drive motor 247 installed on the base body, a disc-shaped gear 246 engaged with the drive motor to rotate, a drive arm 245 of which one side is linked to the other end of the massage roller moving rod 240 and the other side is eccentrically linked to the disc-shaped gear 246, a height adjustment member 260 supporting the other end of the cylindrical guide member to adjust a height of the cylindrical guide member 230, and a top plate cover 270 provided with a straight line groove 271 so that a portion of the massage roller is exposed.

### [Modes of the Invention]

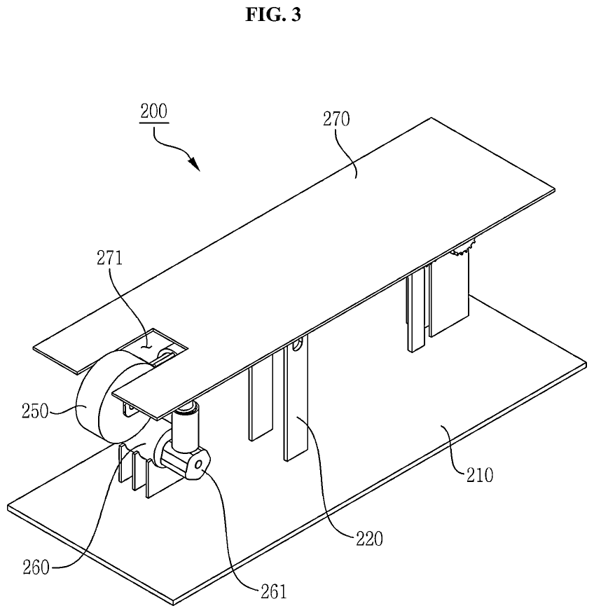

Hereinafter, a technical configuration and operational effects of a prostate massage device 200 according to the present invention will be described in detail with reference to FIGS. 3 to 7.

The prostate massage device 200 according to the present invention is formed in, for example, a hexahedral shape with a size of a width of 400 mm, a length of 300 mm, and a height of 100 mm and formed so that all side portions are covered by a cover, but for convenience of description, will be described with reference to drawings of a structure in which the side portions are open.

As shown in FIGS. 3 to 5, the prostate massage device 200 according to the present invention includes a base body 210, a top plate cover 270 provided with a straight line groove 271 so that a portion of a massage roller 250 is exposed, and a support 220 installed at the center of the base body. A long hole 221 is formed in an upper end portion of the support in a longitudinal direction of the support.

One end of a cylindrical guide member 230 is fixed in the long hole 221 with a fixing pin 222 interposed therebetween. Although not shown in the drawings of the present invention, an elastic member such as a spring may be coupled between the long hole and the fixing pin to absorb an impact when the cylindrical guide member 230 moves along the long hole 221. That is, the spring may be installed between the support and the fixing pin to push the fixing pin 222 upward from the support 220 side.

A massage roller moving rod 240 may be fitted into the cylindrical guide member 230 to reciprocate.

The massage roller 250 is fixed to one end of the massage roller moving rod 240, and a drive arm 245 is linked to the other end. The other end of the drive arm 245 is eccentrically linked to a disc-shaped gear 246 installed on the base body 210. The disc-shaped gear 246 may be rotated by being engaged with a drive motor 247 installed on the base body.

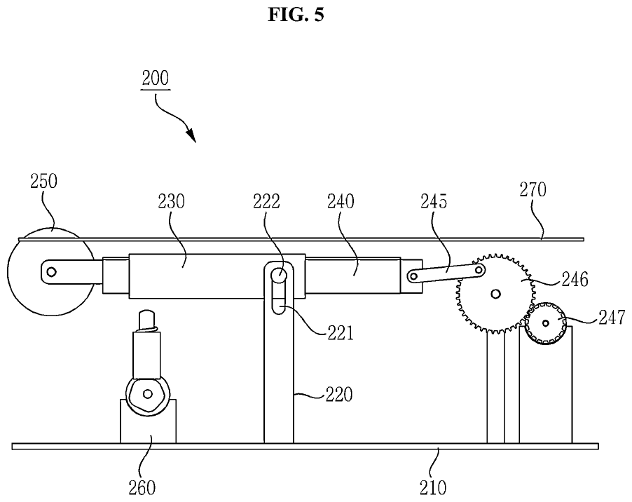

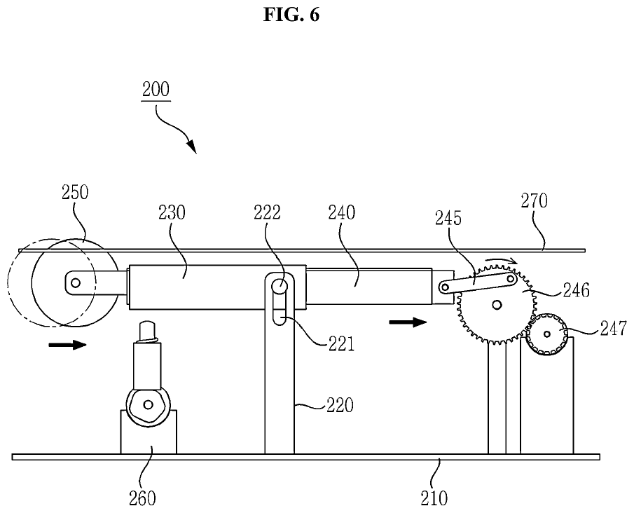

The massage roller moving rod 240, which is fitted into the cylindrical guide member 230 to reciprocate, moves backward from a state of FIG. 5 to a state of FIG. 6 when rotating the disc-shaped gear 246 according to power of the drive motor 247.

As described above, when the massage roller moving rod 240 reciprocates along the cylindrical guide member 230, since the cylindrical guide member 230 may slightly move upward and downward along the long hole 221 with respect to the fixing pin 222 due to the operation of the drive arm 245 eccentrically linked to the disc-shaped gear 246 to move an end portion of the cylindrical guide member 230 to which the massage roller 250 is fixed upward and downward, the massage roller 250 fixed to an end of the massage roller moving rod 240 moves in a streamlined way rather than in the straight line, and thereby the pressing strength of the human body of the massage roller 250 changes depending on positions.

Meanwhile, a height adjustment member 260 is formed on the base body 210 to adjust a height of the cylindrical guide member 230.

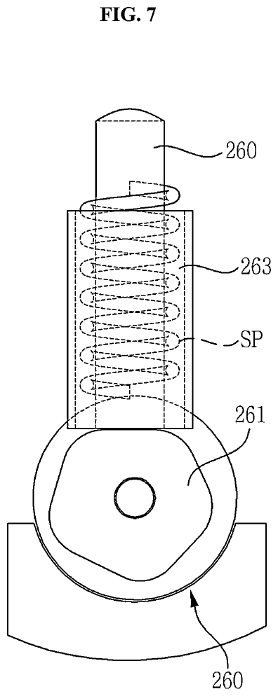

As shown in FIG. 7, the height adjustment member 260 includes an eccentric cam 261 which is rotated by driving of the motor, and an operation pin 262 that moves upward and downward according to the rotation of the eccentric cam. A spring 263 is installed between the operation pin 262 and the eccentric cam 261 to adjust a height and serve as a cushion when the operation pin 262 is in contact with the cylindrical guide member 230. The height adjustment member 260 serves to appropriately adjust a height of the massage roller 250 exposed to the straight line groove 271 of the top plate cover 270.

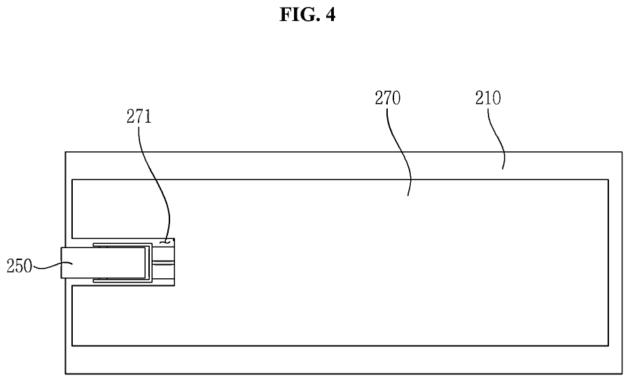

The prostate massage device 200 according to the present invention formed as described above is formed so that, when the user sits on the top plate cover 270, as shown in FIGS. 3 and 4, the massage roller 250 exposed through the straight line groove 271 of the top plate cover 270 in a state in which the massage roller 250 is positioned at the top massages the perineum part of the user while repeating the downward movement according to the driving of the drive motor 247.

The prostate massage device 200 according to the present invention is not limited to the exemplified drawing structures and descriptions and may be implemented by being modified in various ways within the scope of the claims and objects of the present invention.

### INDUSTRIAL APPLICABILITY

There is provided a massage device that is useful for preventing prostate disease in men and urinary incontinence disease in women.

1. A prostate massage device comprising:
a base body;
a support installed at a center of the base body;
a long hole formed in an upper end portion of the support in a longitudinal direction of the support;
a cylindrical guide member of which one end is fixed in the long hole with a fixing pin, which is coupled to the long hole, interposed therebetween;
a massage roller moving rod fitted into the cylindrical guide member to reciprocate;
a massage roller fixed to one end of the massage roller moving rod;
a drive motor installed on the base body;
a disc-shaped gear engaged with the drive motor to rotate;
a drive arm of which one side is linked to the other end of the massage roller moving rod and the other side is eccentrically linked to the disc-shaped gear;
a height adjustment member supporting the other end of the cylindrical guide member to adjust a height of the cylindrical guide member; and
a top plate cover provided with a straight line groove so that a portion of the massage roller is exposed.

2. The prostate massage device of claim 1, wherein the cylindrical guide member is movable along the long hole, and the height adjustment member is in contact with the cylindrical guide member with an elastic member interposed therebetween.
